(19) United States
(12) Patent Application Publication
(10) Pub. No.: US 2006/0060573 A1
(43) Pub. Date: Mar. 23, 2006

(54) Process for preparing a workpiece to be worked with a laser beam, and device for carrying out the process

(76) Inventors: Wolfgang Becker, Ulm (DE); Ralf Bernhardt, Leonberg (DE); Klaus Goth, Sindelfingen (DE); Mike Paelmer, Weil der Stadt (DE); Claus-Dieter Reiniger, Remshalden (DE); Thomas G. Stahs, Ulm (DE); Daniel Zauner, Ballendorf (DE)

Correspondence Address: PENDORF & CUTLIFF, 5111 MEMORIAL HIGHWAY, TAMPA, FL, 33634-7356, US

(21) Appl. No.: 11/229,113

(22) Filed: Sep. 15, 2005

(30) Foreign Application Priority Data
Sep. 15, 2004 (DE) 10 2004 044 533.8

(51) Int. Cl. B23K 26/20; B23K 26/00

(52) U.S. Cl. 219/121.64; 700/166; 219/121.61

(57) ABSTRACT

The invention concerns a process for pretreatment of a workpiece to be processed with a laser beam, as well as a device for carrying out the process. It is the task of the invention to develop a process and a device, which with small expenditure of material and expense, and with few process steps, makes possible an improved weld seam formation for joining workpieces. The invention is comprised therein, that for the pretreatment of a workpiece to be treated with a laser beam, in which on at least one surface of the workpiece with application of a thermal effect of at least one laser beam emitted by a laser source, rises such as knurls are formed, for the positionally correct and undistorted formation of the rises the time and spatial sequence of a relative movement between workpiece and laser beam and the output over time of the laser source are coordinated to each other via a control computer.

### BACKGROUND OF THE INVENTION

1. Field of the Invention

In the laser welding of overlapping corrosion protection coated steel sheets (galvanized sheets), a vaporization of the coating material can occur, which leads to weld failures. For example, in the case of zinced sheets, zinc can explosively vaporize, so that weld splatters result, which reduces the quality of the weld seam. Thus, sheets are so deformed prior to welding, that free space is produced, through which the vapors can rapidly escape.

2. Related Art of the Invention

DE 39 33 408 A1 discloses the lap or web welding of linked sheets is disclosed, in which the sheets are kept spaced apart by knurls or crimps, with the knurls or crimps running next to the laser weld seam. Between the knurls or, as the case may be, beads or crimps, there are free spaces, which form channels for the zinc evaporated during welding.

DE 199 43 752 C1 discloses a joint location or point for laser welded components, in particular for galvanized shaped sheet metal parts, is disclosed, in which gas vapor evacuation channels are provided extending transverse to the lap seams, through which the coating vapors formed during welding can be exhausted freely to the environment. The exhaust channels are formed in the shape of crimps or corrugations.

In DE 38 12 448 C1, a jointing area of two coated thin sheets is shown, in which exhaust gas chambers are produced for receiving the gaseous coating materials formed during laser welding process, in which the sheets abut upon each other along the weld seam with varying radiuses of curvature and are spaced apart from each other on both sides of the weld seam.

In the process for welding of galvanized sheet metal according to EP 687 519 A1, an upper sheet is so deformed in advance of the weld focus of a laser beam, that a linear contact with a lower lying sheet results. Wherein, degassing chambers are formed beside the line of contact. The positioning of the laser beam is produced directly by the positioning of the tool which carries out the deforming.

In the above-mentioned processes, channels are formed by the development of crimps, knurls, or other deformations for escape of the gasses produced during welding. This deformation of a workpiece in advance of welding is produced by specialized devices, which are complex and expensive. The deformations are preformed in a separate deforming device, so that a supplemental transporting of the workpieces to the welding device is necessary. As a rule, supplemental finishing devices and clamping devices are necessary. If a deformation device and a welding device are combined into one piece of equipment, then this brings about limitations with regard to space requirement, and due to the weight, there are dynamic positioning problems, particularly if the device is to be mounted adjacent accompanying clamping devices on the arm of a robot.

In the process known from DE 102 41 593 A1, for laser treatment of coated sheets, topographic changes are produced projecting from a surface of a sheet using a scanner device. The topographic changes produced in the form of an even contoured peak on the surface facing the laser beam by defocusing of a laser beam, or on the side opposite to the laser beam in that the sheet metal is melted all the way through.

DE 102 09 479 A1 discloses a device for laser beam welding of a blunt or stump weld seam, in which a weld optical assembly is provided on a spatially movable carriage. For control of the position of the welding optical assembly and two workpieces relative to each other, the sled is connected with a mechanical or electrical copy feeler or probe. In the welding process, a mechanical feeler follows the contour of one of the workpieces. The workpieces lie adjacent to each other during welding. No particular precautions need to be taken in order to avoid the negative effects of the gas produced during the welding.

In a laser welding process according to DE 100 61 644 A1, the position and movement parameters, such as speed and acceleration, of an object to be welded are determined using contactless sensors. The sensor's signals are processed in a controller using a welding program into position signals for a locationally fixed deflection device, a focusing device, and an output controller of a laser beam. The process allows an increased work space coverage of the laser welding process.

In DE 198 56 347 C2, a laser beam cutting process is described, in which a relative movement between a laser beam and a workpiece to be cut is produced. The relative movement follows the course of a guide groove in a workpiece carrier. The output or power of the laser beam and the supply of a liquid cooling medium are so controlled, that a thermal mechanical tensioning is induced along a separating line, and a melting of the workpiece material is avoided.

### SUMMARY OF THE INVENTION

It is the task of the present invention to provide a process for pretreatment of a workpiece to be processed with a laser beam, and a device for carrying out the process, which enable an improved weld seam formation for joined workpieces with less material consumption and costliness and with few process steps.

The task is solved with a process according to the present invention. A device for carrying out the process is characterized by the process of the present invention. Advantageous embodiments can be seen from the dependent claims.

According to the invention, rises, such as surface burs, knurls, or nubs, or penetration knurls or depressions, are produced on one surface of a workpiece, in the area being joined, by the thermal effect of one laser beam.

The process and the device advantageously allow the combination of the production of the rises with a subsequent finishing process, such as welding or soldering. For this, a computer and a program are employed, with which the time and spatial movement sequence of a workpiece to be provided with knurls, and/or a time and spatial movement sequence of a laser beam on a surface of a workpiece, and the time output or power of the laser beam source, are coordinated relative to each other. Thereby, knurls are produced undistorted on a desired location upon the workpiece independent of the movement of the workpiece and/or the laser beam.

It is essential that the clock frequency or cycle time, with which the control computer coordinates the movement and/or the output control, is changed depending upon the speed and/or the acceleration (this term including deceleration; change in speed) of the relative movement. This allows a control which is optimized with respect to the computer power, and therewith is real-time optimized.

Either the speed and/or the acceleration of the relative movement can be predetermined off-line on the basis of a time and space predetermined track of the relative movement, or the control computer can detect in real time the relative positions of workpiece and laser beam and can determine therefrom online the speed and/or the acceleration of the relative movement. The second variant occurs, for example, on the basis of a fixed welding plan in absolute component coordinates (so called “fixed plan knurls”) or on the basis of a learned sequence program for the production of the rises (so called “teach sentence operation”).

The orientation (learning) of a sequential program occurs typically with the aid of teach-in-functions of the program, in particular, of the transport system of a workpiece. For this, a position detection of the relative coordinates of all involved components, as well as their calibration, in a zero state or situation is necessary. The clock frequency of the on-line position detection and the further relaying to the control computer is dependent upon the speed and/or the acceleration of the relative movement of workpiece and laser beam. The position detection can occur using known image recognition process or via TPC-coordinate robots.

The process is, in particular, applicable for the pre-treatment of steel sheets coated with corrosion protection materials prior to laser welding in the automobile body fabrication. The process requires only a small manufacturing technical investment, so that fabrication costs can be saved or minimized.

The process can occur in various ways. In a first variant, the workpiece is positioned in a transport device. With the transport device, the workpiece is conveyed to a processing area for laser beam processing and is stopped in the processing area. The workpiece is provided with knurls using the laser beam, wherein a processing optical assembly of a laser device is moved in accordance with a program. Subsequently, the workpiece is conveyed out of the processing area using the transport device and is deposited in a delivery or transfer location for subsequent processing steps or is deposited in a device.

Alternatively, the workpiece can be removed from the transport device for the formation of the laser knurls and be delivered into a holder device in the processing area of the laser device. After the formation of knurls using the laser, then the workpiece is removed from the holder device and conveyed on using the transport device.

In a further variant, the workpiece is positioned with the transport device in the processing area of a laser device with a stationary processing optical assembly in accordance with a program and is simultaneously provided with knurls. Subsequently, the workpiece is conveyed out of the work area and deposited in a transfer location or in a device for subsequent processing steps.

In the sequence of the course of a further variant, a workpiece is so positioned in a transport device, and the processing optical assembly of a laser beam device is simultaneously so positioned in accordance with a program, that knurls are produced as desired at a joining location of the workpiece. As in the previously mentioned variants, the workpiece is subsequently conveyed out of the work area and deposited in a transfer location or in a device for subsequent processing steps.

In a further variant, the workpiece is provided in a transport device and is conveyed into the work area of a laser beam device. For subsequent provision with knurls, the workpiece remains in the transport device, or is deposited by the transfer device in a holder device in the work location. During the process of imparting knurls, the workpiece and work optical assembly of the laser beam device are not moved. The processing or machining optical assembly includes a device for deflection of the laser beam, which is so controlled in accordance with a program, that knurls are produced at the desired locations with the desired shapes. The workpiece is subsequently conveyed out of the processing area and deposited in a transfer location or in a device for subsequent processing steps.

For a subsequent processing step, such as for example, laser welding, the workpiece can remain in the holder device, which was used during the laser formation of knurls.

If a workpiece has knurls imparted to it in a transport device, when the transport device so designed, depending upon the type, position, and shape of the knurls to be produced, that the workpiece can be held positionally correct, or as the case may be, can be moved. The elements, in particular the clamping elements, of the transport device do not produce any barriers to access for the processing laser beam. The workpiece is so received in the transport device, or as the case may be, is so moved in the transport device, that the processing locations are situated within a predetermined positional tolerance. The transport device can be associated with a provider of position measurement values of the workpiece, wherein the measurement values are supplied to a control device. The recording of measurement values can occur controlled by a clock tempo independent of a change of the speed vector of the movement of the workpiece. The recording of the measurement values can be obtained with means for image recognition, for example contained on a pallet conveyer, wherein in a control device the coordinates of a robot arm are processed, to which the laser beam device or the workpiece is secured.

The transport device can be designed for receiving two or more of the workpieces to be processed. In the production of penetrating knurls, the workpieces are previously positioned at a distance. In the production of surface knurls, the workpieces are firstly so positioned, that at least one joining location to be provided with knurls is facing the processing optical assembly of a laser beam device. After imparting knurls with the laser beam, the workpieces are positioned in correct positions relative to each other for laser welding. As transport device, there can be employed, for example, a robot with a gripper, a pallet conveyer belt, a chain magazine, transport pallets, so-called overhead systems or shuttles, roller conveyors and the like.

To the extent that the knurls are formed directly in the transport device, holding devices (jigs, clamping devices, hold-down devices) can be employed for the workpieces to be provided with knurls and to be welded. A holder device can be rigidly connected with a transport device or be provided on the transport device exchangeably via an exchange system. If the holder device is employed during knurl formation and welding, then the holder device receives a lower lying workpiece preferably positionally correct for the production of the surface knurls. The processing locations are not overshadowed by the holder device, or as the case may be, by clamping elements of the holder device with respect to a processing laser beam. After the formation of knurls, a second workpiece is superimposed and is clamped with the first workpiece at the surfaces to be joined, such that subsequently a joining by welding can be carried out. In the production of penetration knurls (negative knurls, depressions), two workpieces to be joined are held positionally correct in a holder device at a distance of more than 1 mm. After the production of the penetration knurls, the workpieces are clamped to each other in the holder device so that subsequently the joining by welding can be carried out.

As clamp element in the transport device or in the holder device, preferably a unidirectional clamping element, such as a vacuum or magnet, is employed. The clamping elements are so provided that no blockage of the laser beam occurs. The clamping elements need apply clamping forces only to the extent that the position of the processing locations is reliably maintained even in the case of rapid changes of the workpiece speed.

The laser beam device can be equipped with standard welding optical assemblies without moveable optical elements. Further, laser heads with a so-called scanner optic can be employed, which contain rapidly moving mirrors for deflection of a laser beam, and which are controllable in real time. The laser beam device can preferably be equipped with sensors which provide, through a control device, the diagnostic signals necessary for operation. The laser beam sources themselves can likewise be provided to be controllable in real time. The laser beam sources provide high energy laser beams operating in pulses with pulse durations in the range between 0.1 ms and 500 ms or in continuous operation with 0.5 kW to 10 kW. As laser beam source, semi-conductor lasers or gas lasers can be employed. For beam guidance between a laser beam source and a laser head, preferably light guides (optical fibers) or beam guiding tubes can be employed.

In order to coordinate the involved system components to each other in space and time, a control process is run, which brings about that the laser knurls appear on the workpiece positionally correct and undistorted independent of the basic movement of the workpiece or the processing optical assembly. The control of the laser beam source, the processing optical assembly, the transport device, and the holder device with clamping devices is adapted to the respective circumstances. Time non-critical sequences, such as for example, the clamping of a workpiece in a locationally fixed clamping device prior to the knurl forming process, are carried out using conventional control devices. Time critical sequences, such as for example, the control of a moved processing optical assembly, are carried out with a special computer, which can be integrated into one of the participating controller components, such as the controller for the processing optical assembly or the transport device.

The control process in the laser formation of knurls and laser welding occurs with the aid of a computer, which as separate control computer typically synchronizes three components during the formation of the knurls; a robot, a processing optical assembly, and a laser source. The synchronization occurs with real time communication with a controller of the transport system for a workpiece and/or the processing optical assembly with a work cycle of typically 12 ms (IPO-cycle). Further, the processing optical assembly is controlled with control elements in two or three degrees of freedom and the output controller of the laser beam source is controlled in real time in a cycle of typically 1 ms.

It is essential that the cycle frequency, with which the control computer undertakes the determination and coordination of the movement and/or output control, is changed depending upon the speed and/or the speed changes of the relative movement of workpiece and laser beam.

For this, a so-called master computer can read the position of the transport device and control the processing optical assembly and laser beam source according to this position. The program running in the master computer can produce, on the basis of a weld plan or program, knurls in absolute workpiece coordinates. This involves a so-called knurl-forming using a fixed plan. Further, knurl data can be recorded in the sequence plan of the transport device and be processed. This involves a so-called teach-sentence operation.

A further possibility is comprised therein, that the master computer controls the said three components in accordance with off-line determined tracks and trigger functions.

The establishment or adjustment of a sequence program occurs typically with the assistance of appropriate extended teach-in-functions of the controller of the transport device. It is a precondition to this that calibrated data is obtained with respect to the relative position of all involved components, which are determined in their zero position via specific calibration processes. Off-line programming possibilities are, likewise, as needed, appropriately adapted, or, as the case may be, developed.

For the case of the use of a moved processing optical assembly or stationary workpiece, the position of the processing optical assembly is determined in real time and transformed in a common reference system. The master computer triggers a production process for the individual knurls according to a suitable trigger strategy, such as for example according to the distance, however, at the earliest at the point in time, at which the accompanying or moved-along scanned field of the processing optical assembly reaches the locations of the knurls to be produced. The master computer compensates during the knurl forming process the movement of the moved-along processing optical assembly, so that the knurl pattern appears without distortion on the desired location on the workpiece.

In the case of the use of a static processing optical assembly and a moving workpiece, the position of the clamped workpiece is determined in real time, transmitted to the master computer, and there is converted in a common reference system, for example, the transport device or the processing optical assembly. The master computer triggers a production process for the individual knurls according to a suitable trigger strategy, such as for example the distance; however, at the earliest, upon entry of the target point of a knurl in the static scan field of the processing optical assembly. The master computer compensates during the knurl-forming process for the movement of the workpiece, so that the knurl pattern appears at the desired location upon the workpiece without distortion.

In the case of the use of a moved processing optical assembly and a moved workpiece, both the position of the moved workpiece, as well as the position of the moved processing optical assembly, are determined in real time, relayed to the master computer, and there are converted into a common reference system. The master computer triggers the production process for the knurls according to a suitable trigger strategy, such as for example the distance, however, at the earliest at the point in time at which the scan field of the processing optical assembly reaches the non-stationary location of the knurl to be produced. The master computer compensates during the knurl-forming process the movement of both moved-along systems, so that the knurl pattern appears on the workpiece undistorted and on the desired location.

In the case of the use of a static processing optical assembly and a static workpiece, the position of the workpiece relative to the locationally fixed processing optical assembly is determined only once in the calibration process upon reaching the knurl-forming station, is relayed to the master computer, and there is converted into the reference system of the processing optical assembly. The master computer starts and controls the production process for the knurls according to the fixed taught positions.

The knurl process can be realized with the aid of sensors. In particular, sensors can be provided for control of the quality of the knurls, which sensors are preferably connected with the processing optical assembly. Camera based sensor systems are particularly suited. Further, a sensor for determining the workpiece position, or as the case may be, the workpiece movement, can be employed, in particular in the case when a workpiece is introduced with a transport device in the work area of a scanner optical assembly.

The speed of the transport device and a processing optical assembly, or as the case may be, of the scanner mirrors of the processing optical assembly, are so coordinated to each other, that the processing speed for the process of the formation of knurls is not hindered. In the cases in which the workpiece is moved, the formation of knurls can occur while passing a laser beam device.

### BRIEF DESCRIPTION OF THE DRAWINGS

The invention is described in greater detail in the following on the basis of illustrative examples, where there is shown in:

FIG. 1 a schematic representation of a sequence with moved processing optical assembly and locationally fixed component,

FIG. 2 a schematic of a sequence with locationally fixed processing optical assembly and moving component,

FIG. 3 a schematic of a sequence with moved processing optical assembly and moved component, and

FIG. 4 a schematic of a sequence with locationally fixed processing optical assembly and locationally fixed component.

### DETAILED DESCRIPTION OF THE INVENTION

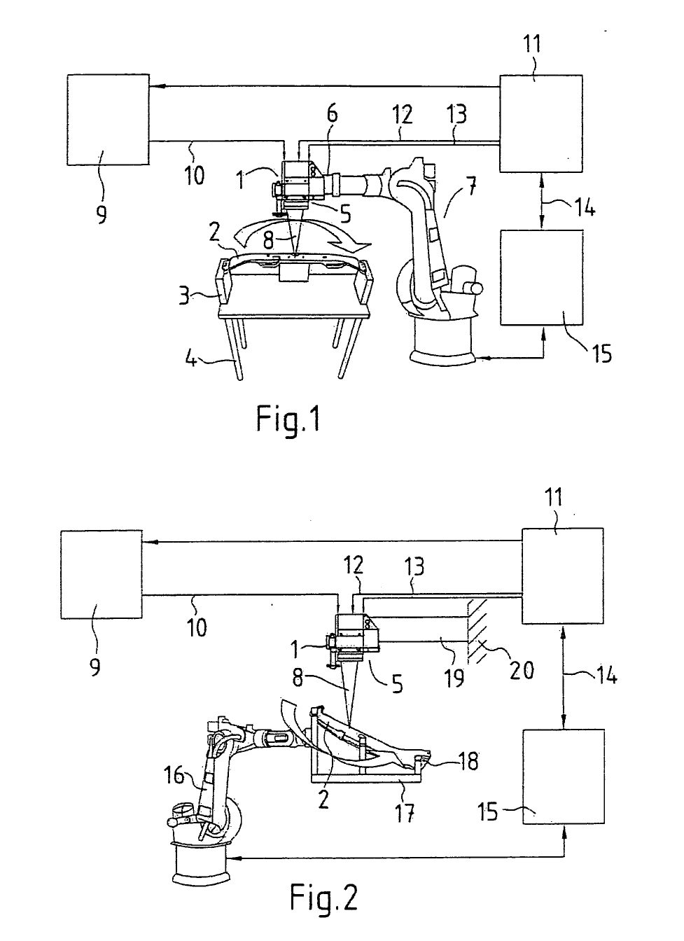

In FIG. 1 there is shown in schematic representation a sequence with moved processing optical assembly 1 and locationally fixed component 2. A robot serving as transport device picks up, with a suitable component gripper, the component 2 upon which knurls are to be formed and deposits it positionally correct in a device 3, which is secured to a frame 4. The side of a component 2 upon which knurls are to be formed faces upward for production of surface knurls. The space above the area of the component 2 to be provided with knurls and having joining flanges is freely accessible for the processing optical assembly 1. The processing optical assembly 1 is a component of a laser processing head 5, which is secured to a flange 6 of a robot 7. The position of the component 2 is fixed in the clamping fingers of the device 3. The clamping forces of the component 2 lie in the range of 100N. The clamping fingers are located spaced apart by approximately 300 mm along the joining surface. The clamping fingers are so designed, that they project only 10-20 mm beyond the surface of the component 2 and, besides this, taper or narrow upwards by approximately 15°. The processing locations for the knurl-forming process are not blocked thereby.

The processing optical assembly 1 is a 2D-laser scanner. Using two rapidly moving mirrors, a laser beam 8 can be moved within a processing field over the surface of the component to be positioned and moved. The robot 7 has mobility about 6 axis. With the robot 7, the processing optical assembly 1 can be moved with a distance of approximately 300 mm over the surface of the component 2. The track of the robot 7 and the position of the laser knurls are previously taught or learned. The knurl-forming process occurs during the robot guided movement of the laser scanner over the surface of the component 2. As laser, a diode pumped YAG-laser 9 with a maximal continuous output of 3-4 kW is employed. The laser light is transmitted with a light guiding cable 10 from the laser 9 to the laser processing head 5. The laser 9 is connected to a control computer 11 for switching on and off and for controlling the power. Further, control lines 12, 13 lead from the control computer 11 to the actuators for the deflector mirrors of the processing optical assembly 1. The control computer 11 has an interface and connections 14 to a robot controller 15, which is connected with the robot 7.

With the control computer 11, the positional data of the processing optical assembly 1 are determined during the work cycles of the robot 7. The control computer 11 triggers the production process for the production of knurls at the point in time, at which the accompanying scanned field of the processing optical assembly 1 reaches the location of the knurls to be produced. The control computer 11 computes in real time from the detected position data of the processing optical assembly and the previously learned positions for the knurls, the compensation movement of the deflection mirror and the tasks or requirements for the laser power. Via an interface card, the control signals are transmitted to the laser processing head 5 and the laser 9 in a speed dependent ms-cycle. The production process for the knurls lasts a few 10 ms. For each welding point for joining the component 2 with a different component, 1-5 knurls are produced. The robot 7 moves the processing optical assembly 1 at 10-25 m/min over the area of the component 2 to be provided with knurls. Between the individual knurls, the laser beam is moved by the deflection mirror with maximal speed to the next knurl to be produced. The track of the robot need not be laid out directly over the knurls to be produced. It is sufficient when the knurls lie in the scan field of the processing optical assembly 1 for a sufficient amount of time during the passage-by for the production of knurls in the process. After the knurl-forming process, the clamping fingers are opened. The transport robot removes the component 2 out of the device 3 and lays it in a welding device for the subsequent welding process.

In the following description, to the extent that reference numbers have been previously employed, these then refer to equivalent elements or signals.

FIG. 2 shows a schematic of a sequence with locationally fixed processing optical assembly 1 and moved component 2. The transport robot 16 picks up, from a supply container, with a suitable component gripper 17, the component 2 to be provided with knurls. The component gripper 17 is equipped with clamping elements 18, which fix the component 2 in the component gripper 17. Location, force, and design of the clamping elements 18 are comparable with those in the illustrative embodiment according to FIG. 1. The component 2 is provided with knurls in the component gripper 17 of the transport robot 16 during the supply movement going through the welding device. Therein, the transport robot 16 moves the component 2, or as the case may be, the areas of the component 2 to be provided with knurls, with a speed of 10-20 m/min at a distance of approximately 500-650 mm below the processing lens 1, which is provided fixed on the frame 20 with a holder or mount 19. As laser 9, a pulsed YAG-laser with a pulse duration of 5-10 kW is employed.

The control computer 11 detects the position, or as the case may be, the movement of the component 2 clamped in the component gripper during the cycle of the transport robot 16. The control computer 11 triggers the production process for the individual knurls upon the entry of the target point for the knurl into the stationary scanning field of the processing lens 1. The control computer 11 computes in real time the compensation movement of the two deflection mirrors of the processing lens 1 and a stroke or lift movement of a third scanner axis during the knurl-forming process, so that the knurl pattern appears at the desired location upon the component 2 without distortion. Further, the control computer 11 determines the synchronized power requirement for the laser 9. Via an interface card, control signals are relayed or conveyed in ms-cycles from the control computer 11 to the processing lens 1 and the laser 9.

After the completion of the imparting of the knurls on the component 2, the transport robot 16 lays the component 2 positionally correct with the surface knurls facing downwards in the laser welding device. In this laser welding device, the partner to be joined to the component 2 provided with knurls has previously been inserted.

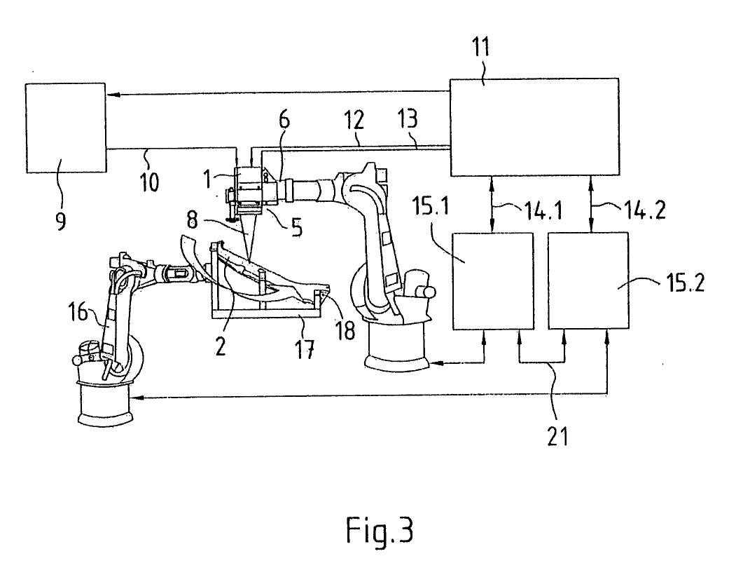

In a sequence according to FIG. 3 with movable processing lens 1 and moved component 2, a robot 7 and a transport robot 16 are employed, which carry the processing lens and the component 2. Each robot 7, 16 is associated with a robot controller 15.1, 15.2, which are connected with a control computer 11 via lines 14.1, 14.2. The robot controllers 15.1, 15.2 communicate with each other via lines 21. The sequence according to FIG. 3 offers, on the basis of the movement abilities of both robots 7, 16, the greatest possible flexibility. The movements of the robots 7, 16 are coordinated to each other, so that formation of knurls is possible even at difficult to reach locations. Further, the comments with regard to FIGS. 1 and 2 also apply.

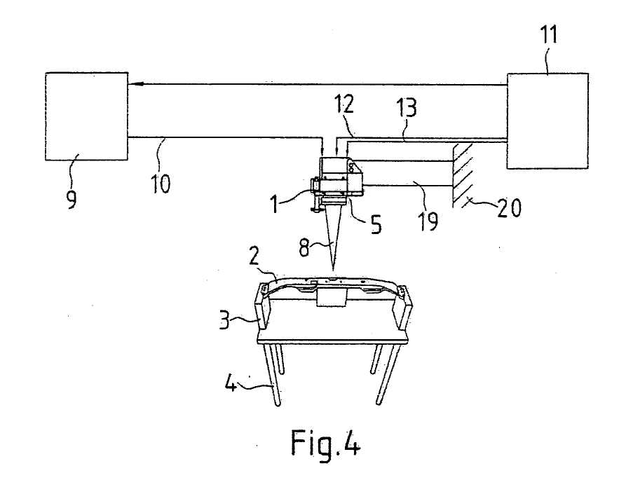

In a sequence according to FIG. 4, a processing lens 1 and a component 2 are provided locationally fixed. The deflection area of the deflection mirror in the processing lens 1, the distance of the surface of the component 2 and the laser power of the laser 9 make possible the provision of knurls over a large processing area, so that a repositioning of the component 2 is not necessary. In this variant, one can dispense with robots and associated controllers. Otherwise, the comments with respect to FIGS. 1 and 2 apply.

Reference Number List

1 Processing Lens
2 Component
3 Device
4 Frame
5 Laser Processing Head
6 Flange
7 Robot
8 Laser Beam
9 Laser
10 Light Guiding Cable (optical fiber)
11 Control Computer
12, 13 Control Line
14 Connecting Line
15 Robot Controller
16 Transport Robot
17 Component Gripper
18 Clamping Element
19 Holder
20 Frame
21 Line

1. Process for laser preparing a coated workpiece, in which rises are to be formed on at least one surface of the workpiece using the thermal effect of at least one laser beam emitted by a laser source, wherein the workpiece and/or laser beam are moved relative to each other, wherein for the locationally correct and undistorted formation of the rises, the sequence of the relative movement in time and space between workpiece and laser beam and the power output of the laser source over time are coordinated with each other via a control computer, thereby characterized, that the cycle frequency, with which the control computer undertakes the coordination of the movement and/or output control, is changed depending upon the speed and/or the acceleration (change in speed) of the relative movement.

2. Process according to claim 1, thereby characterized, that the speed and/or the acceleration of the relative movement are determined off-line on the basis of a track predefined in time and space.

3. Process according to claim 1, thereby characterized, that the control computer determines in real time the relative positions of the workpiece and laser beam and therefrom determines or calculates the speed and/or the acceleration, and namely preferably
on the basis of a preset welding plan in absolute component coordinates, or
on the basis of a learned sequence program for the production of the rises.

4. Process according to one of the preceding claims, thereby characterized, that the workpiece is brought into the field of work of a movable laser beam device, and that the laser device is moved relative to the resting workpiece, and the laser source of the laser device is so controlled, that the rises are formed.

5. Process according to one of the preceding claims, thereby characterized, that the workpiece is brought into the field of work of a locationally fixed laser device, and that the workpiece is moved relative to the laser device, and the laser source of the laser device is so controlled, that the rises are formed.

6. Process according to one of the preceding claims, thereby characterized, that the workpiece is brought into the field of work of a movable laser device, and that the workpiece and the laser device are both moved relative to each other, and the laser source of the laser device is so controlled, that rises are formed.

7. Process according to one of the preceding claims, thereby characterized, that the workpiece is brought into the field of work of a locationally fixed laser device, and that a laser deflection device and the laser source of the laser device are so controlled, that the rises are formed upon the resting workpiece.

8. Process according to one of the preceding claims, thereby characterized, that the workpiece is held upon a transport device during the production of the rises.

9. Process according to claim 8, thereby characterized, that with a position measuring system connected with the transport device, the positional data of the workpiece is generated and transmitted to a control device.

10. Process according to one of the preceding claims, thereby characterized, that the workpiece is brought out of the transport device into a holder device in the field of work of a laser device for production of the rises.

11. Process according to one of the preceding claims, thereby characterized, that the workpiece is mated at the joining surfaces with a further workpiece for subsequent joining and is welded by a laser beam in the holder or clamping device.

12. Process according to one of the preceding claims, thereby characterized, that the relative movement between workpiece and laser beam are carried out by a robot.

13. Process according to one of the preceding claims, thereby characterized, that two workpieces are brought into the field of work a laser device overlapping and separated from each other, that the source of the laser beam of the laser device is so controlled, that the rises are produced at the joining surfaces of one of the workpieces, that the workpieces are mated and clamped to each other at their joining surfaces spaced apart by the rises, and that the workpieces are joined to each other by laser welding.

14. Process according to one of the preceding claims, thereby characterized, that a first workpiece is brought into a work area of a laser beam device, that a laser source of the laser device is so controlled, that the rises are formed at a joining surface of the first workpiece, that a second workpiece is mated overlappingly with the first workpiece at the joining locations spaced apart by the rises and is thus fixed, and that the workpieces are joined by laser welding.

15. Process according to one of the preceding claims, thereby characterized, that the laser source used for production of the rises is also employed for laser welding.

16. Device for carrying out the process according to one of the preceding claims, with at least one laser source of which the laser beam is adapted for formation of rises upon one surface of a workpiece, wherein the laser beam is movable relative to the workpiece, wherein the output of the laser source is adjustable over time, and wherein a control computer is employed, which is connected via control lines where the device for the time and spatial relative movement of laser beam and workpiece and with a device for controlling over time the output, thereby characterized, that the control computer is so designed, that the cycle frequency, with which the control computer undertakes the coordination of the movement and/or power control, is variable depending upon the speed and/or the change in speed of the relative movement.

17. Device according to claim 16, thereby characterized, that a position measuring system is provided for measuring the position and orientation of the workpiece, and that the position measuring system is in communication with the control computer.
